(19) United States
(12) Patent Application Publication
(10) Pub. No.: US 2012/0082770 A1
(43) Pub. Date: Apr. 5, 2012

(54) Food servings with cooked tender flesh and crispy skins

(75) Inventors: Maxime Jean Jerome Bilet, Bellevue, WA (US); Grant Lee Crilly, Seattle, WA (US); Nathan P. Myhrvold, Bellevue, WA (US); Christopher Charles Young, Seattle, WA (US); M.G. Johnny Zhu, Bellevue, WA (US)

(73) Assignee: Elwha LLC, a limited liability company of the state of Delaware

(21) Appl. No.: 12/924,805

(22) Filed: Oct. 4, 2010

(51) Int. Cl. A23L 1/312; A23L 1/317

(52) U.S. Cl. 426/291; 426/464; 426/438; 426/289; 426/296; 426/646; 426/523; 426/518; 426/445

(57) ABSTRACT

Cooked meat servings have puffed, crunchy skins surrounding tender and succulent flesh portions. Entire meat pieces including the flesh portions and the skin portions covering or encasing the flesh portions are cooked in a manner that leaves neither portion under- or over-cooked.

### TECHNICAL FIELD

The present application relates, in general, to culinary science and food preparation technology. In particular, the application relates to savory and palatable prepared meat products.

### DESCRIPTION

Attention is being given to preparing meat servings for human consumption. Entire meat pieces including the flesh portions and the skin portions covering or encasing the flesh are cooked in a manner that leaves neither portion under- or over-cooked. The cooked meat servings may have puffed, crunchy skins surrounding tender flesh portions.

Methods for preparing meat servings for consumption are presented.

The meat preparation and/or cooking methods described herein may be exploited to prepare small quantities (e.g., individual food servings prepared in home kitchens) and/or large quantities (e.g., commercial food servings prepared in industrial kitchens or other commercial food processing industry).

The meat preparation and/or cooking methods may be carried out in stages. Pre-cooked or partially cooked items may be stored (e.g., frozen or unfrozen) for later cooking to completion.

The meat servings may be prepared from raw pieces of poultry (e.g., duck or chicken breast), fish or other animal meat (e.g., pork). An individual raw meat piece may include a muscle or flesh portion that is covered by a protective skin portion. The skin portion may include water and fat held in a mesh of connective tissue (collagen fibers). The skin portion may be an original skin portion, a reconstituted skin portion, or a simulated skin portion. Further, a layer of fat may lie between the skin and flesh portions. The fat layer may include fat-filled cells held in place by a fine network or mesh of collagen fibers. The fat layer may be a natural fat layer. However, in instances where the raw meats are deficient in natural fat, the fat layer may be a reconstituted fat layer that has been inserted or injected between the skin portion and the flesh portions.

In the cooking methods presented herein each portion of the raw meat piece (i.e., the flesh portion and the skin portion covering or encasing the flesh) may be cooked to a respective degree so that neither the flesh portion nor the skin portion is under- or over-cooked. To achieve this, the raw meat piece may be cooked in increments or stages in a controlled manner. The cooking increments or stages may be directed to softening of the skin portion, drying the skin portion, rendering fat, puffing the skin portion, and keeping the flesh portion tender and not over-cooked. The cooking increments or stages may be performed sequentially and/or simultaneously on all or individual portions of the raw meat piece.

One or more of the cooking increments or stages may involve “sous-vide” cooking, which is a cooking technique that is intended to maintain the integrity of ingredients by heating them for an extended period at relatively low temperatures. In sous-vide cooking, the meat servings may be cooked for a long time in airtight containers (e.g., airtight plastic bags) placed in hot water at or well below its boiling point (e.g., at 60° C. or 70° C.). The flesh portion of a raw piece of meat (with or without skin) may, for example, be cooked and made succulent or tender by such sous vide cooking. Alternatively, the flesh portion may be cooked without airtight containment at temperatures well below the boiling point of water (e.g., at 52° C. to 65° C.) under controlled humidity conditions.

Softening the Skin

The cooking methods may involve drying the skin by controlled removal of sufficient fat and water from the skin portion to leave it suitably dry. A suitably dried skin may be delicate and crispy, hard and crunchy, or soft and chewy. The controlled dehydration of the skin portion may be accomplished without overcooking the encased flesh portion and leaving it tender, moist, juicy and succulent. Even as water is being removed from the skin during the cooking, some of it may contribute to softening or tenderization of the skin by hyrdolyzation reactions that convert tough collagen into tender gelatin. The hydrolyzation of collagen fibers into gelatin may be referred to herein as “gelatinization.” The rate of skin softening (i.e. collagen gelatanization) is a function of the type or source and age or maturity of the collagen, and the cooking temperature. The rate may become significant above an “activation” temperature, for example, a temperature of about 65° C. The rate may be substantially slow at temperatures below the activation temperature, but may increases rapidly at temperatures above the activation temperature. The cooking methods may use low skin softening temperatures (e.g., as in sous vide cooking techniques) to avoid prolonged exposure of the enclosed flesh portion to high temperatures that can result in overcooking or over drying of the enclosed flesh portion.

Rendering Fat

The cooking methods render the fat layer by rupturing the fat cells and weakening of the collagen mesh holding the fat cells. The cooking methods may involve heating the meat pieces to temperatures that are sufficiently high to convert or melt the solid fat into liquid oil. Holes, fissures, or cracks in the skin may provide pathways or channels for the oil to escape through the skin. The escape holes may be created, for example, by perforating the skin. Perforating the skin with a hard wire brush may, for example, create multiple escape holes.

In some instances, the skin portion may wick juices from the flesh portion and become soggy. To avoid this, the cooking methods may involve only partial rendering of the fat layer. A portion of the fat layer may be left in place to provide a physical barrier that keeps the skin portion from wicking juices from the flesh portion and becoming soggy.

Removal of Water

Water may be removed from the skin portion to at least partially dehydrate or dry the softened or gelatinized skin portion. Any suitable technique for extracting water from the softened or gelatinized skin portion may be used to at least partially dehydrate the softened or gelatinized skin portion. A suitable technique may, for example, involve heating or baking the gelatinized skin portion in a temperature and/or humidity-controlled oven. Another suitable technique may involve vacuum drying. Yet another suitable technique may involve placing the gelatinized skin portion in contact with dry salt or other hygroscopic agent.

For convenience in description an at least partially dehydrated skin portion may be referred to herein as a “dehydrated” or “dried” skin portion without reference to the extent of dehydration or dryness except in a few instances where an explicit reference may be necessary for an understanding of the disclosed subject matter.

A straightforward drying technique for drying the skin portion is to steadily evaporate all or most of the water from the gelatinized or softened skin portion (e.g., by baking or vacuum drying). Evaporating all or most of the water may lead to a tough, inflexible, and glass-like skin portion. Rather than stretching or deforming, the dried skin portion may simply crack under pressure. Depending on how thick the skin portion is, it may be crunchy and pleasantly snap when bitten into. However, thick dried skin portions may be tooth-shatteringly hard.

Puffing the Skin

Further use of a “puff” drying technique may cause the skin potion to puff into a delicate cellular structure that crisply shatters rather than cracks when bitten into. A suitable quantity of residual water droplets in the dehydrated skin portion may be flash heated to rapidly vaporize and form steam bubbles that will puff the skin portion.

To prepare the skin portion for application of the puff drying technique, any drying technique (e.g., baking, vacuum drying, or contact with a hygroscopic agent, etc.) may be used to evaporate and or otherwise extract most of the water out of the skin portion. However, not all of the water content may be extracted or driven out of the skin portion. Purposefully, a small quantity of water may be left behind in the skin portion. The skin portion may be dehydrated or dried only to the extent that it is neither too wet, nor too dry. The partially dehydrated or dried skin portion with small quantities of residual water (e.g., about 10%) may appear to be hard, glassy and completely dried to touch or feel. The partially dried skin portion may be cooled to ensure that water vapor trapped in the heated skin portion (e.g., after baking) condenses into water droplets throughout the skin portion. Then, the partially dried skin portion may be puffed by flash heating the water droplets throughout the skin portion into steam. The partially dried skin portion may be subject to an intense and fast heating step (e.g., in a deep fryer or a very hot oven or) to flash heat the water droplets and convert them into steam bubbles. The flash heating may allow heat to quickly conduct through the partially dried glassy skin portion. The skin portion may be heated sufficiently during the flash heating to soften and make it rubbery, for example, in manner a similar to a hard caramel that becomes soft and pliable when heated. Precautions may be taken so that the heating is sufficiently fast to soften the skin portion even as droplets of water are vaporizing so that the mechanically expanding steam-filled bubbles will stretch the skin's delicate cellular structure and cause the skin portion to puff. In the absence of such precautions (e.g., if the skin portion is not heated fast enough) the water droplets may flash into steam and expand before the skin portion softens. Rather than puffing the skin portion, the rapidly expanding steam may mechanically fracture the skin portion structures and escape.

Whether or not the skin portion puffs may depend on the amount of the residual water in the partially dried skin portion. Excessive amounts of residual water may cause the skin portion to heat and soften too slowly. Unduly low amounts of residual water may yield in an insufficient number or size of steam bubbles to puff the skin portion. The suitable amount of water left to be left behind in the partially dehydrated or dried skin portion may determined by trial error by its effect on the puffing of the skin portion. In practice, the suitable amount of residual water and the flash heating parameters (e.g., heating rate, peak temperature, and durations) required to puff the skin portion may be determined empirically.

Keeping the Flesh Portion Tender

In addition to having moisture barriers to prevent moisture from migrating from the flesh portion into the cooked skin portion, the cooking methods may also involve creating a heat barrier to prevent the high cooking temperatures that may be involved in drying and/or puffing the skin portion from overcooking the enclosed flesh portion. Tender cuts of meat such as duck breast or pork loin may remain moist and succulent even under the flash heated or deep fried puffed skin portions. A heat barrier, which prevents migration of high levels of heat into the interior of the flesh portion during flash heating of the skin portion, may be formed by freezing an outer layer of the flesh portion. The heat barrier may be formed by freezing the outer layer of the flesh portion, for example, prior to the flash heating. Alternatively, the heat bather may be formed by freezing the outer layer of the flesh portion prior to softening the skin or rendering the fat. A suitable thin frozen outer layer may be obtained, for example, by application of dry ice or other cryogen to the outer surfaces of the meat item or any other available technique.”

The frozen layer (i.e. ice) may take large amounts of heat to melt back to water, and, until it melts, its temperature can never be above freezing. This fact may be exploited to get crisp skin without overcooking the tender flesh it covers. A thin frozen layer may suffice to protect the flesh portion from over cooking during both flash heating or deep frying of the skin portion and also during any extended heating required for fat rendering (e.g., for meats such as duck breast that have thick layers of fat between their skin and flesh portions). An outer layer of the flesh portion of raw meat piece (e.g., duck breast) may be frozen before rendering fat layers. The outer layer of the flesh portion may for example, be frozen by laying the rare meat piece skin-side down on a dry ice At nearly −80° C./−112° F., dry ice will freeze the skin, fat, and flesh rapidly. The fat may then be rendered by heating (e.g., by searing the meat in a pan or on a hot griddle for about 5 minutes). The frozen outer flesh layer underneath the skin portion and fat layer may thaw sufficiently slowly preventing the flesh portion from cooking even as the fat is rendered.

A prepared meat item (e.g., a pork loin roast) may have both a crispy skin portion and succulent flesh portion. The crispy skin portion may be riddled with fragile bubbles that shatter when bitten into, giving it a distinctly crisp sensation. The crispy skin portion may tend to stay crisp for an extended period because its bubbly structure may help to isolate the skin portion from moisture in the flesh portion. Likewise, a thin residual layer of fat (a partially rendered fat layer) between the crispy skin portion and the flesh portion may also act as a moisture barrier and help keep the skin portion dry and crisp.

A reconstituted or simulated puffed skin material may be prepared by separating skin from meat (e.g., poultry, piscine, porcine, or bovine skin). The separated skin portion may be first softened or gelatinized and dehydrated, for example, by suitable heating. Sodium bicarbonate (baking soda) may be added to or mixed with the skin being heated to assist with conversion of collagen to gelatin and to improve flavor of the final skin product.

The suitable heating for softening or gelatinizing the skin portion may include cooking the skin portion sous vide, in hot oil, or in a pressure cooker. For example, the skin portion may be cooked sous vide in hot water at about 95° C. for about 12 hours. Alternatively, for example, the skin portion may be cooked in hot oil at temperature between about 95° C. to 120° C. or the skin portion may be cooked in a pressure cooker for about 60 minutes at about 15 psi. The softened or gelatinized skin portion may be further dehydrated or dried leaving behind sufficient residual water content to make it suitable for puffing by deep-frying or hot oven-treatment.

The dehydrated skin portion may be crumbled, cut, chopped or pulverized into small pieces to prepare material for reconstituted or reconstructed skins. The dehydrated skin portion pieces may be graded by size, for example, using a series of suitable sieves or screens. Further, the dehydrated skin portion pieces may be reserved or stored in a dry environment (e.g. in a container with a silica gel or other desiccant) for later use. Alternatively, the dehydrated skin portion pieces may be refrigerated or frozen for storage and later use. Like other common meat or food products, the dehydrated skin portion may be stored for extended periods (e.g., up to six months) without spoiling.

In the preparation of a meat item for consumption, the dehydrated skin portion pieces may be applied or coated on to surfaces of a flesh portion of the meat item with suitable binders or adhesives to serve as reconstituted or reconstructed skin. A suitable binder agent may, for example, be a starch, a hydrocolloid (e.g., a cellulosic gum, alginate, xanathan gum, etc.), or a protein (e.g., albumen/egg white). A barrier agent to retain moisture and prevent oil absorption during cooking may be first applied to the surface of the flesh portion before or with the application of the binder agent and/or the dehydrated skin portion pieces. A suitable binder/barrier agent may, for example, be methylcellulose.

The reconstituted or reconstructed skin applied to the surfaces the flesh portion may be flash heated (e.g., via deep frying or a hot oven treatment) to provide a puffed skin crust for the cooked meat item. For example, the meat item with the surface layer of the dehydrated skin portion pieces may be deep fried for about 30 seconds in hot oil so that the dehydrated skin portion pieces form a golden crispy crust.

The texture and crispiness of the final product may depend on the sizes of the dehydrated skin portion pieces used to prepare the reconstituted or reconstructed skin. Pieces with an average size of 1 mm may yield an excellent crispy texture and adhere better to the food than other sizes. Further, washing the freshly prepared or stored dehydrated skin portion pieces with a food grade acid solution (e.g., a 5% acetic solution) before puffing or adhering may encourage formation of the puffed skin crust structures and increase the percentage of pieces that successfully puff up.

The following non-limiting EXAMPLES 1 and 2 illustrate cooked meat servings with crispy skin, intermediate meat items, and the methods of preparing the same.

### EXAMPLE I

### Pork Roast with Puffed Skin

A pork roast with puffed skin was prepared. Convention roasting can turn pork skin soggy and chewy, or hard and crunchy, or both. However, here the pork roast was prepared with a reconstructed pork skin with a delicate, crispy consistency. The skin was cooked separately from the flesh portion of the roast, chopped into a crumble, and deep fried. The intense heat of the deep fry caused residual water in the crumble to expand as steam and to puff the crumble in a manner similar to pop corn. The puffed crumble was applied as reconstructed skin to the surfaces of the flesh portion of the roast as reconstructed skin. The final serving was a roast with a light and brittle coating, which shattered in the mouth releasing a shower of flavor.

To prepare the crumble, the raw pork loin piece was trimmed and skin layers were stripped from the flesh portion. The stripped skin layers softened or gelatinized by cooking. In one instance, a separated skin layer was cooked sous vide at 95 C/203 f for about 12 hours. In another instance, a separated skin layer was cooked in a pressure cooker at 15 psi for about 20 minutes. In both instances, a small amount of baking soda (e.g., less ½% by weight) was added to the separated skin layers to assist with conversion of collagen to gelatin and to improve the appearance and flavor of the final skin product.

The gelatinized skin layers were placed skin side down on a flat surface and a scraping tool was used to gently scrape away fat form the flesh-portion side surfaces of the gelatinized skin layer. Then the gelatinized skin layers were placed on a sheet tray in an oven at 115 C/240 F unit they were dry and rigid. Typically, the dried skin layers had a residual water content of about 10%-15% by weight. The dried skin layers were then chopped into small pieces. The chopped pork-skin pieces were then graded for size using sieves to select fragments about 1 mm in diameter. These were stored in an airtight container with silica gel desiccant for later use.

To prepare the flesh portion of the pork roast, a trimmed pork loin was cooked to a core temperature of about 60C/140F using either sous vide or in a humidity controlled oven. Next, the pork loin was plunged into liquid nitrogen for approximately 30 seconds to freeze an out surface layer. This optional freezing of an outer layer was expected to prevent heat from reaching into and overcooking the flesh portion when the roast was later deep-fried after coating with the crumbled pork skin.

To encourage adhesion of the pork skin crumble, pre-gelatinized starch was sifted on to the surfaces of the pork loin roast. Further, a foam prepared from methylcellulose was applied to the surface. The pork loin roast was then rolled on a bed of the crumbled pork skin to form an even coating.

The coated pork loin roast was then deep fried in oil for just long enough (about 30 seconds) for the crumbled pork skin particles to puff up and form a golden crispy crust. This amount of deep-frying effectively thawed the frozen layer of flesh and restored its temperature to approximately 60C/140F.

### EXAMPLE II

### Cryoseared and Cryorendered Duck Breast

Duck breast with crispy skin was prepared.

The duck breast was butchered so that it was surrounded by extra skin. The extra skin was folded up and over the backside of the breast. The extra skin compensated for the shrinkage of the skin that occurred during later cooking, leaving a crisp, even layer. The folded skin over the flesh portion also served to protect the flesh portion from escaping steam and splattering oil during later cooking.

In preparation for softening the skin and fat rendering, the skin and underlying fatty tissue were perforated with a sharp tool (e.g. using a stiff wire dog hairbrush or a Jaccard knife). The perforations were sufficiently small so that no marks were visible after cooking.

An outer layer of the flesh portion was frozen by pressing the duck breast skin side down on a flat sheet of dry ice. Contact for about 25 minutes with the dry ice may have frozen more than the thickness of the skin and the fat layer, but less than about than ¼ of the flesh underneath the skin. The duck breast was pressed flat on the dry ice so that the frozen duck breast had a flat rigid shape amenable to uniform contact with the surface of a hot griddle.

Then, the frozen duck breast was seared to soften the skin and to partially render the fat layer. The frozen duck breast was pressed skin side down on a hot griddle for about five minutes. The thin skin and relatively dry fat thawed quickly, but the thicker layer of frozen flesh filled with ice thawed slowly. The thawing rate of the frozen layer was sufficiently slow to block heat from the hot griddle from the reaching and cooking the flesh portion. The time on the hot griddle (e.g., 5 minutes) was limited so that the fat layer was only partially rendered. The residual fat may serve as a moisture barrier keeping juices in the flesh portion from leaching out.

Next, the duck breast was heated to cook the flesh and dry the softened skin. Cooking temperatures no higher than suited to the tenderize flesh of the duck breast were used. Higher temperatures were not necessary as the collagen in the skin had already been gelatinized and the fat rendered. Internal cooking temperatures of about 58° C./136 F resulted in a tender and succulent cooked flesh portion. In some instances, the duck breast was cooked in a humidity-controlled oven. In other instances, the duck breast was cooked sous vide.

Once the duck breast was cooked through, and the skin dried, it was again placed in contact with the dry ice bed, in preparation for puffing the skin. The cooked duck breast was placed on the dry ice bed for a short time (e.g., three to five minutes) to form a thin frozen layer of flesh adjoining the skin portion. The duck breast was placed skin down with a warmed satchel of loose ballast on it flesh side to reduce cooling of the bulk of the cooked flesh portion.

Finally, the duck breast prepared for serving by searing the skin in a hot pan filled with enough oil to completely submerge the skin. The skin quickly crisped as the skin puffed and turned a golden brown.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of cooking, comprising:
gelatinizing a skin portion;
dehydrating the gelatinized skin portion; and
crumbling the dehydrated skin portion into pieces.

2. (canceled)

3. The method of claim 1, wherein crumbling the dehydrated skin portion comprises chopping the dehydrated skin portion into pieces.

4. (canceled)

5. The method of claim 1, wherein crumbling the dehydrated skin portion further comprises storing the dehydrated skin portion pieces in a controlled environment.

6. (canceled)

7. The method of claim 1, further comprising, washing the dehydrated skin portion pieces with a food grade acid solution.

8. The method of claim 7, wherein the food grade acid solution comprises an acetic acid solution.

9. The method of claim 1, further comprising, deep frying the dehydrated skin portion pieces so that the pieces are puffed.

10. The method of claim 1, further comprising:
obtaining a food product; and,
applying a coating of the dehydrated skin portion pieces to a surface of the food product.

11. The method of claim 10, further comprising, flash heating the food product with the surface coating of the dehydrated skin portion pieces so that the dehydrated skin portion pieces are puffed.

12. The method of claim 10, further comprising, deep frying the food product with the surface coating of the dehydrated skin portion pieces so that the dehydrated skin portion pieces so that the pieces are puffed and form a golden crispy crust.

13. (canceled)

14. The method of claim 10, wherein obtaining a food product comprises obtaining a pork loin.

15. The method of claim 14, wherein obtaining a pork loin comprises:
trussing the pork loin with a shape-retainer; and
cooking the trussed pork loin.

16. The method of claim 15, wherein cooking the trussed pork loin comprises cooking the trussed pork loin to a core temperature of about 52° C.-72° C.

17. (canceled)

18. The method of claim 10, wherein applying a layer of the dehydrated skin portion pieces to a surface of the food product comprises freezing an outer layer of the food product.

19. The method of claim 18, wherein freezing an outer layer of the food product comprises spraying with or submerging the food product in liquid nitrogen.

20. The method of claim 18, wherein freezing an outer layer of the food product comprises contacting the food product with a cold surface.

21. The method of claim 10, wherein applying a layer of the dehydrated skin portion pieces to a surface of the food product comprises applying starch or other film- forming hydrocolloid on to the surface.

22. The method of claim 10, wherein applying a layer of the dehydrated skin portion pieces to a surface of the food product comprises applying a barrier agent that provides better adhesion of dehydrated skin, minimizes moisture migration, and/or prevents oil absorption during cooking.

23. The method of claim 1, wherein gelatinizing the skin portion comprises cooking the skin portion sous vide.

24. The method of claim 1, wherein gelatinizing the skin portion comprises cooking the skin portion sous vide.

25. The method of claim 24 wherein cooking the skin portion sous vide comprises cooking the skin portion at about 95° C. for about 12 hours.

26. The method of claim 1, wherein gelatinizing the skin portion comprises cooking the skin portion in hot oil at temperature between about 95° C. to 120° C.

27. The method of claim 1, wherein gelatinizing the skin portion comprises cooking the skin portion in a pressure cooker.

28. The method of claim 1, wherein gelatinizing the skin portion comprises cooking the skin portion in a pressure cooker for about 60 minutes at about 15 psi or an equivalent time and pressure combination.

29. The method of claim 1, further comprising, removing excess fat from the gelatinized skin portion.

30. The method of claim 29, wherein removing fat from the gelatinized skin portion comprises scraping fat from gelatinized skin portion.

31. The method of claim 1, wherein dehydrating the gelatinized skin portion comprising baking the gelatinized skin portion in an oven.

32. The method of claim 1, wherein dehydrating the gelatinized skin portion comprising vacuum drying the gelatinized skin portion.

33. The method of claim 1, wherein dehydrating the gelatinized skin portion comprising placing the gelatinized skin portion in contact with salt.

34. A food product prepared in accordance with the method of claim 1.

35. A food product prepared in accordance with the method of claim 6.

36. A food product prepared in accordance with the method of claim 7.

37. A food product prepared in accordance with the method of claim 8.

38. A method of cooking a meat portion having a flesh portion and a skin disposed thereon, comprising:
freezing the skin and at least an adjoining part of the flesh portion of the meat portion;
heating the skin to a gelatinizing temperature T1, to at least partially gelatinize it (skin) while the frozen adjoining part of the flesh portion thaws; and
heating the flesh portion with the at least partially gelatinized skin to an internal cooking temperature T2.

39. (canceled)

40. The method of claim 38, wherein T1 is greater or equal to about 70° C.

41. The method of claim 38, wherein T2 is less than about 70° C.

42. The method of claim 38, wherein T2 is about 56° C.-65° C.

43. (canceled)

44. The method of claim 38, wherein the meat portion is butchered to have extra skin flaps, and wherein the method further comprises folding the extra skin over a side of the meat portion.

45. The method of claim 38, wherein freezing the skin and an adjoining outer part of the flesh portion comprises contacting the skin with a cryogen.

46. (canceled)

47. The method of claim 38, wherein freezing the skin and an adjoining outer part of the flesh portion comprises freezing about a ¼ inch thick layer of the flesh portion.

48. The method of claim 38, wherein providing a meat portion having a flesh portion and a skin disposed thereon comprises providing a meat portion having a fatty tissue layer underneath the skin.

49. The method of claim 48, wherein freezing the skin comprises freezing the fatty tissue layer underneath the skin.

50. The method of claim 38, further comprising, perforating the skin.

51. (canceled)

52. The method of claim 38, wherein heating the skin to a gelatinizing temperature T1 comprises rendering fat underneath the skin

53. The method of claim 38, wherein heating the skin to a gelatinizing temperature T1 comprises searing the meat portion in a pan or on a hot griddle.

54. (canceled)

55. The method of claim 38, further comprising, drying the at least partially gelatinized skin.

56. (canceled)

57. (canceled)

58. The method of claim 55, further comprising, puffing the skin.

59. The method of claim 58, wherein puffing the skin comprises flash heating the skin.

60. The method of claim 58, wherein puffing the skin comprises first cooling the dried skin.

61. The method of claim 60, wherein cooling the dried skin comprises contacting the dried skin with a cryogen or a cold surface.

62. (canceled)

63. The method of claim 55, wherein cooling the dried skin comprises freezing at least an outer layer of the flesh portion underneath the skin.

64. The method of claim 55, wherein flash heating the skin comprises flash heating the skin to vaporize at least a fraction of its water content in situ.

65. (canceled)

66. (canceled)

67. A food product prepared in accordance with the method of claim 38.

68. A food product prepared in accordance with the method of claim 55.

69. A food product prepared in accordance with the method of claim 64.
